(19) United States
(12) Patent Application Publication
(10) Pub. No.: US 2014/0222303 A1
(43) Pub. Date: Aug. 7, 2014

(54) METHOD FOR CONTROLLING DUMP BODY OF A HAULING MACHINE

(71) Applicant: Caterpillar S.A.R.L., Geneva (CH)

(72) Inventors: BADRI NARAYANAN CHARY, CHENNAI (IN); MARK ROBERT BLACKBURN, CHENNAI (IN)

(73) Assignee: Caterpillar S.A.R.L., Geneva (CH)

(21) Appl. No.: 14/245,330

(22) Filed: Apr. 4, 2014

(51) Int. Cl. B60P 1/16

(52) U.S. Cl. CPC B60P 1/16
USPC 701/50

(57) ABSTRACT

A method for controlling a dump body of a hauling machine wherein the hauling machine includes an engine, at least one extendable cylinder, a lift energy source, and a controller is provided. The method includes initiation of the dump operation, detection of payload from the payload signal, calculation of engine throttle based on the payload information, and detection of machine speed based on the machine speed signal. Upon detection of machine speed, if the machine speed coincides with the first selective dump command, the transmission is disengaged and the payload is released at selective dump angle. If the machine speed coincides with the second selective dump command, the payload is released at selective dump angle.

### TECHNICAL FIELD

The present disclosure relates generally to hauling machines. More specifically, the present disclosure relates to method for controlling dump body of a hauling machine.

### BACKGROUND

Currently, hauling machines are often used as a way to transport material from a loading location to a dumping location. The hauling machine may have the capacity to receive and dump hundreds of tons of materials. The hauling machine may include a dump body configured to contain or hold the material. The dump body may be raised by extending a plurality of fluid cylinders to dump the material at the dumping location. However, prior to raising the dump body, an operator needs to ensure the proper machine speed and the orientation of the hauling machine. Further, during dumping, the operator may control the engine to maintain a fluid pressure in the plurality of fluid cylinders to raise the dump body. Also, the operator may need to manually ensure that the dump body is inclined at an optimum dump angle to dump the material completely. As a result, over the period of a work shift, the multiple manual dump operations contribute to fatigue experienced by the operator. Moreover, due to inconsistencies in manual dumping operations hauling production may be adversely affected.

The present disclosure is directed to solve one or more problems associated with hauling machines, as cited above.

### SUMMARY OF THE DISCLOSURE

The present disclosure relates to a method of controlling a dump body of a hauling machine. The hauling machine includes an engine, at least one extendable cylinder, a lift energy source, and a controller. The engine is configured to drive a transmission. The extendable cylinder is attached to the dump body and is configured to incline the dump body to evacuate payload. The extendable cylinder is connected to the lift energy source and is configured to move the dump body. The controller is configured to receive a payload signal, an engine throttle signal, and a machine speed signal.

According to the present disclosure, the method for controlling the dump body of the hauling machine comprises prompting if the auto dump operation is enabled. After determining that the auto dump operation is enabled, payload information is detected from the payload signal and engine throttle is calculated based on the payload information. The controller controls the engine to operate at calculated engine throttle. Further, machine speed is determined based on the machine speed signal. Upon detection of the machine speed, if the machine speed coincides with a first selective dump command, the transmission is disengaged and the payload is released at selective dump angle. If the machine speed coincides with a second selective dump command, the payload is released at the selective dump angle.

### BRIEF DESCRIPTION OF THE DRAWINGS

FIG. 1 is a side view of a hauling machine with the dump body at a rest position, in accordance with the concepts of the present disclosure;

FIG. 2 is a side view of the hauling machine shown in FIG. 1, with the dump body at a dumping position, in accordance with the concepts of the present disclosure;

FIG. 3 is a block diagram illustrating a layout of an auto dump control for the hauling machine of FIG. 1; and

FIG. 4 is a flowchart illustrating a method for auto dump control for the hauling machine of FIG. 1 and in accordance with the concepts of the present disclosure.

### DETAILED DESCRIPTION

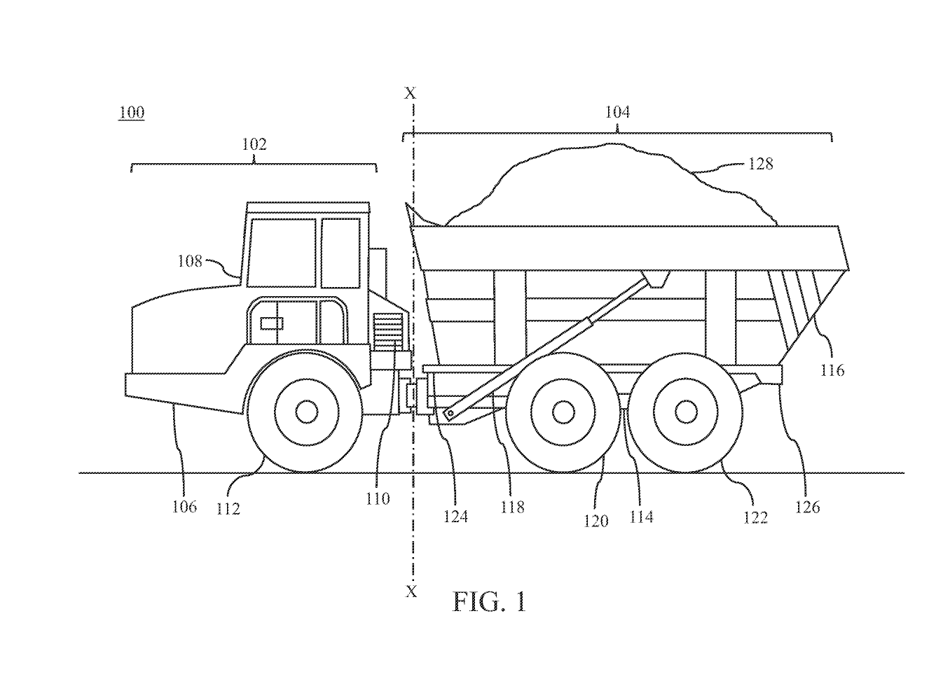

Referring to FIG. 1, shown is a hauling machine 100 which includes a front unit 102 and a rear unit 104. The front unit 102 and the rear unit 104 may be pivotably coupled to pivot about an axis X-X. The front unit 102 includes a front frame 106, an operator cab 108, and an engine 110. The front frame 106 is mounted on a first pair of front wheel assemblies 112 associated with the front unit 102. The front frame 106 of the front unit 102 may be configured to support the operator cab 108 and the engine 110. The operator cab 108 may include devices that receive input from a machine operator which may indicate a desired maneuvering of the hauling machine 100. Specifically, the operator cab 108 may include one or more operator interface devices. Examples of operator interface devices include, but are not limited to, a joystick, a steering wheel, and/or a pedal (none of which are shown but are well known in the industry).

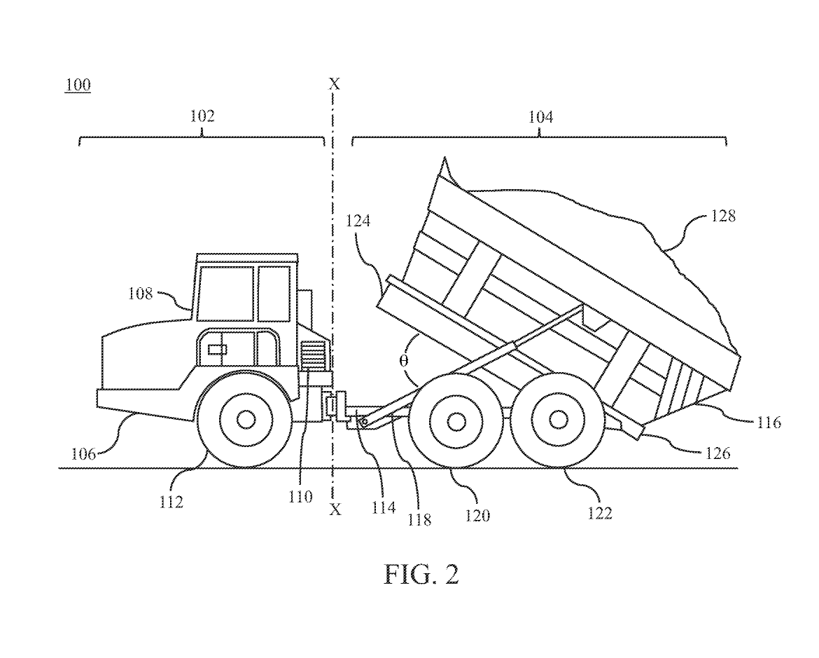

The rear unit 104 includes a rear frame 114, a dump body 116, and at least one extendable cylinder 118. The hauling machine 100 may include a single hydraulic cylinder, for example, a pair of extendable cylinders as is customary or a plurality of cylinders to raise the dump body 116. The rear frame 114 is mounted on a first pair of rear wheel assemblies 120 and a second pair of rear wheel assemblies 122, associated with the rear unit 104. The rear frame 114 supports the pivotable dump body 116 and the extendable cylinder 118. The dump body 116 has a first end 124 and a second end 126. In an embodiment, the first end 124 of the dump body 116 is the portion which is raised while dumping a payload 128. The second end 126 is the portion where the tipping of the dump body 116 occurs (FIG. 2). The dump body 116 may be configured to carry the payload 128 and may be coupled to the extendable cylinder 118. The extendable cylinder 118 may be coupled to the dump body 116. The extendable cylinder 118 may be configured to tip the dump body 116 at a dump angle (θ) relative to the rear frame 114 (FIG. 2). In an alternative embodiment of the present disclosure, the extendable cylinder 118 may be a hydraulic cylinder or a hydro-pneumatic cylinder.

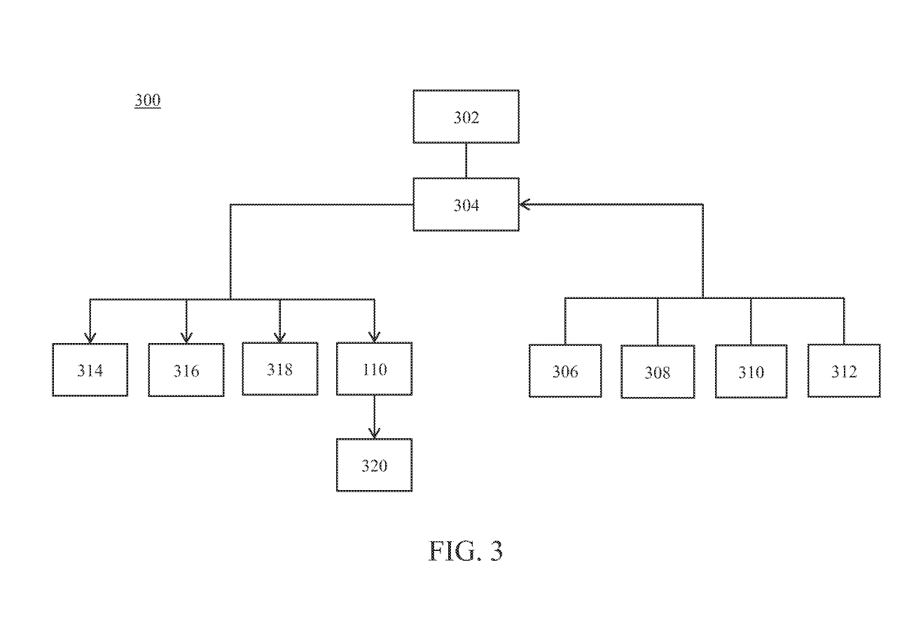

Referring to FIG. 3, an auto dump control for the hauling machine 100 will now be described. An auto dump control system 300 includes a graphical display 302 and a controller 304. The graphical display 302 may include a plurality of input buttons (not shown) to operate the auto dump control system 300. At least one input key of the plurality of input buttons (not shown) on the graphical display 302 may be used to enable and disable an auto dump operation. The auto dump operation may be enabled for at least one of a first selective dump command and a second selective dump command. In the first selective dump mode, the payload 128 of the dump body 116 is dumped when machine speed of the hauling machine 100 is zero and the dump body 116 is inclined at a selective dump angle. In the second selective dump mode, the payload 128 is dumped at a pre-determined machine speed of the hauling machine 100 at the selective dump angle (such dump mode typically corresponds with a material spreading operation by hauling machine 100). The selective dump angle of the dump body 116 at which the auto dump operation is required takes place, may be entered by the operator with the help of the at least one input key of the plurality of input buttons (not shown) on the graphical display 302. In an embodiment, the dump angle of the dump body 116 may be a default value for the auto dump operation. After enabling the auto dump operation and entering the selective dump angle by the plurality of input buttons (not shown) on the graphical display 302, the initiation of the auto dump operation may be prompted by the operator with the help of a hoist lever (not shown) or any other initiating device or means known in the art.

In an exemplary embodiment, the graphical display 302 may also be configured to display a video from a rear view camera (not shown). The rear view camera (not shown) may be fitted on a hauling machine 100 and may be configured to display events of the dump operation of the payload 128 from the dump body 116.

The graphical display 302 may be connected to the controller 304 through data links for the purpose of transmitting and receiving information. Examples of the data links may include, but are not limited to a controller area network bus automotive network (CANBUS) and/or (CAT) data link. The controller 304 is configured to receive a payload signal, an engine throttle signal, and a machine speed signal. In an alternative embodiment of the present disclosure, the auto dump control system 300 may include more than one controller to receive and transmit one or more of the payload signal, the machine speed signal, and the engine throttle signal.

The controller 304 receives outputs from various sensing sources such as a machine speed sensor 306, a payload sensor 308, a dump body angle sensor 310, and a cylinder sensor 312. The present disclosure contemplates the use of one or more of such certain sensors.

As mentioned above, the controller 304 is configured to receive inputs from the machine speed sensor 306. The machine speed sensor 306 is configured to monitor the machine speed of the hauling machine 100. The machine speed sensor 306 sends the machine speed signal to the controller 304. The controller 304 extracts the information of the machine speed form the machine speed signal and assesses if the machine speed is suitable for the dump operation in accordance with the first selective dump command or the second selective dump command. Based on the machine speed extracted from the machine speed signal, the controller 304 generates outputs to control transmission 314, service brake 316, and park brake 318.

The controller 304 is configured to monitor the payload 128 of the dump body 116 with the help of the payload sensor 308. The payload sensor 308 calculates the payload 128 in the dump body 116 and sends the information of the payload 128 as the payload signal to the controller 304. The controller 304 extracts the information of the payload 128 from the payload signal. Based on the payload 128, the controller generates outputs to the engine 110 which in turn controls a lift energy source 320. The lift energy source 320 is connected to the extendable cylinder 118 and is configured to actuate the extendable cylinder 118. In an embodiment, the lift energy source 320 can be a hydraulic pump, a pneumatic pump, or a motor. The controller 304 calculates a ramp rate required for the lift energy source 320 to lift the dump body 116 carrying the payload 128. On calculation of the ramp rate for the lift energy source 320, the controller 304 calculates an engine throttle for the engine 110 based on the required ramp rate. The engine 110 is controlled by the controller 304 to operate at the calculated engine throttle in order to provide the required ramp rate to the lift energy source 320. The lift energy source 320 operates at the required ramp rate to provide fluid to the extendable cylinder 118 to extend the extendable cylinder 118. Pressure of the fluid in the extendable cylinder 118 results in expansion and contraction of the extendable cylinder 118. The expansion and retraction of the extendable cylinder 118 raises and lowers the dump body 116, respectively.

Also, the controller 304 is configured to receive inputs from the dump body angle sensor 310. The dump body angle sensor 310 is configured to monitor the dump angle of the dump body 116. The dump body angle sensor 310 sends the dump angle information to the controller 304. If the dump body 116 tips or tilts beyond a predefined dump angle, the dump body angle sensor 310 may send a warning to the controller 304. Upon receiving the warning of excess tipping of the dump body 116, the controller 304 commands the controller 304 to stop tipping operation of the dump body 116. In addition to this, the dump body angle sensor 310 also monitors if the dump body 116 is raised to be inclined at the selective dump angle for dumping.

The cylinder sensor 312 is configured to monitor the position of the extendable cylinder 118. The cylinder sensor 312 sends the information of the position of the extendable cylinder 118 to the controller 304.

In operation, the operator may drive the hauling machine 100 to the dumping location. At the dumping location, the operator may enable the auto dump operation by the at least one input key of the plurality of input buttons (not shown) on the graphical display 302. The operator may also enter the selective dump angle for the dump body 116 for dumping the payload. The auto dump operation may be initiated by the hoist lever (not shown) or any other actuating means known in the art. The controller 304 determines if the auto dump operation is enabled. Upon confirmation that the auto dump operation is enabled, the controller 304 determines the machine speed of the hauling machine 100 from the machine speed signal sent by the machine speed sensor 306. In a situation, where the machine speed of the hauling machine 100 coincides with the machine speed set for the first selective dump command, that is, machine speed is equal to zero, the controller 304 sends signals for shift of the transmission 314 to neutral. In an exemplary embodiment of the present disclosure, the controller 304 may send signals to apply the service brake 316 and the park brake 318. If the machine speed of the hauling machine 100 coincides with the pre-determined machine speed set for the second selective dump command, the controller 304 signals the transmission 314 to perform necessary gear limiting.

Further, the controller 304 receives the payload signal related to payload 128 of the dump body 116. Based on the payload 128 of the dump body 116, the controller 304 controls the engine 110 to operate at the calculated engine throttle so that engine 110 provides the lift energy source 320 with the required ramp rate. The lift energy source 320 provides the fluid to the extendable cylinder 118 and increases the fluid pressure in the extendable cylinder 118. The increase in the fluid pressure in the extendable cylinder 118 results in the expansion of the extendable cylinder 118. Hence, the extendable cylinder 118 lifts the dump body 116 and the payload 128 is released at the dumping location.

After dumping the payload 128 from the dump body 116, the controller 304 sends signal to de-energize the lift energy source 320. When the lift energy source 320 de-energizes, there is a decrease in the ramp rate. Hence, the fluid pressure in the extendable cylinder 118 decreases and the extendable cylinder 118 contracts and lowers the dump body 116 to the rest position, as shown in FIG. 1. At this point, each of the dump body 116, the lift energy source 320, the extendable cylinder 118, the transmission 314, the service brake 316, the park brake 318, and the engine 110 are restored to initial states, that is, the state of operation before initiation of the auto dump operation.

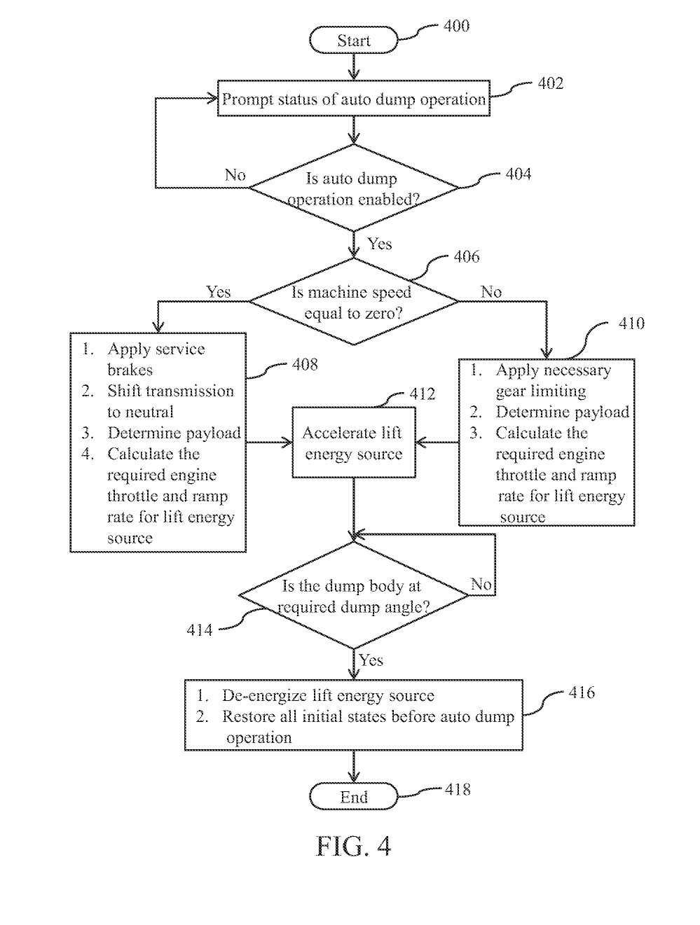

Referring now to FIG. 4, a method for dump control for the hauling machine 100, in accordance with the concepts of the present disclosure will now be described. The auto dump operation for the hauling machine 100 is initiated at step 400. At 400, the auto dump operation is enabled the at least one input key of the plurality of input buttons (not shown) on the graphical display 302 and the auto dump operation is initiated by the hoist lever (not shown) or any other actuating means known in the art. The method proceeds to step 402.

At step 402, the controller 304 prompts the status of the auto dump operation, that is, if the auto dump operation is enabled. The method proceeds to step 404.

At step 404, the controller 304 determines if the auto dump operation is enabled. If the auto dump operation is not enabled, the method goes back to step 402. If the auto dump operation is enabled, the method proceeds to step 406.

At step 406, based on the machine speed signal, the controller 304 determines if the machine speed of the hauling machine 100 is zero. If the machine speed of the hauling machine 100 is zero, the method proceeds to step 408 as per the first selective dump command. If the machine speed is not zero and coincides with the pre-determined speed (S) set for the second selective dump command, then the method proceeds to step 410 as per the second selective dump command.

At step 408, the controller 304 sends signals to apply service brake 316, shift the transmission 314 to neutral, and apply the park brake 318. The controller 304 then determines the payload based on the payload signal and calculates the engine throttle and the required ramp rate for the lift energy source 320 to lift the dump body 116. The method proceeds to step 412.

At step 410, the controller 304 sends signals to transmission 314 for necessary gear limiting. The controller 304 then determines the payload based on the payload signal and calculates the required engine throttle and the ramp rate for the lift energy source 320. The method proceeds to step 412.

At step 412, the controller 304 sends the signal to the engine 110 to accelerate the lift energy source 320 for the required ramp rate. On acceleration of the lift energy source 320, the extendable cylinder 118 expands and the dump body 116 is lifted to dump the payload 128. The method proceeds to step 414.

At step 414, the controller 304 determines if the dump body 116 is inclined at the selective dump angle. If the dump angle is equal to the selective dump angle, then the method proceeds to step 416, else the method goes back to step 412.

At step 416, after the payload 128 is dumped from the dump body 116, the controller 304 sends signals to the engine 110 to de-energize the lift energy source 320. When the lift energy source 320 de-energizes, the dump body 116 lowers to the rest position. Also, each of the dump body 116, the lift energy source 320, the extendable cylinder 118, and the engine 110 are restored to initial state, that is, the state before initiation of the auto dump operation. The method ends at step 418.

### INDUSTRIAL APPLICABILITY

In operation, the auto dump control system 300 allows the operator to enable the auto dump operation. Upon determining the initiation of the auto dump operation, the controller 304 receives the payload signal and the machine speed signal from the payload sensor 308 and the machine speed sensor 306, respectively. The controller 304 extracts the machine speed from the machine speed signal received by the machine speed sensor 306. The controller 304 determines if the machine speed coincides with the first selective dump command or the second selective dump command. After determination of one of the first selective dump command and the second selective dump command, the controller 304 obtains information of the payload 128 and calculates the ramp rate required by the lift energy source 320 to lift the dump body 116. Based on the required ramp rate, the controller 304 calculates the engine throttle for the engine 110 to energize the lift energy source 320 to lift the dump body 116. Subsequently, the controller 304 sends a signal to energize the lift energy source 320 to provide fluid in the extendable cylinder 118 for building suitable fluid pressure. Hence, controlling the engine 110 to operate at the calculated engine throttle aids in the achievement of fuel economy by limiting the engine throttle to a calculated value based on the payload.

As compared to existing dump control systems, the disclosed auto dump control system 300 prevents machine abuse by the operator, as upon the determination of initiation of the auto dump operation by the controller 304, there is reduced need for interference by the operator to achieve functionality of the auto dump control system 300. This is a contributing factor towards operator safety. Also, it reduces operator fatigue to a considerable extent, as it reduces the number of operations to be performed by the operator during the dump operation.

Further, for dumping operations primarily aimed at spreading the material, it is desired that the material is being dumped when the hauling machine 100 is moving at a desired speed and the dump body 116 is inclined at the desired selective dump angle. The proposed auto dump control system 300 enables the operator to initiate the auto dump operation for such spreading operations. Upon initiation of the auto dump operation, the auto dump control system 300 allows the controller 304 to receive payload signal, calculate required engine throttle, and extract machine speed. At this point, the controller 304 determines if the machine speed coincides with the desired speed of the second selective dump command. On determining that the machine speed is the desired speed, the controller 304 allows the dumping of the payload 128 at the selective dump angle.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method of controlling a dump body of a hauling machine having: an engine adapted to drive a transmission; at least one extendable cylinder attached to the dump body to incline the dump body to evacuate payload therein, a lift energy source connected to the at least one extendable cylinder to move the dump body; and a controller configured to receive a payload signal, an engine throttle signal and a machine speed signal, the method comprising:
prompting enablement of an auto dump operation;
detecting payload information from the payload signal;
calculating engine throttle based on the payload information;
controlling the engine throttle to cause the engine to provide the calculated engine throttle to the lift energy source;
detecting machine speed based on the machine speed signal; and at least one of:
(1) releasing the payload coinciding with a first selective dump command by receiving the machine speed signal, disengaging the transmission, and initiating dumping at selective dump angle; and
(2) releasing the payload coinciding with a second selective dump command by initiating the dumping at selective dump angle.
